(19) United States
(12) Patent Application Publication
(10) Pub. No.: US 2007/0172562 A1
(43) Pub. Date: Jul. 26, 2007

(54) ROTATABLE FROZEN CONFECTION AND SUPPORT

(75) Inventor: Tao Cristobal Medina Quintanilla, Santiago (CL)

Correspondence Address: BELL, BOYD & LLOYD LLP, P.O. Box 1135, CHICAGO, IL, 60690, US

(73) Assignee: NESTEC S.A., Vevey (CH)

(21) Appl. No.: 11/697,873

(22) Filed: Apr. 9, 2007

Related U.S. Application Data
(63) Continuation-in-part of application No. PCT/EP05/10665, filed on Oct. 4, 2005.

(30) Foreign Application Priority Data
Oct. 8, 2004 (CL) 26012004

(51) Int. Cl. A23B 4/06

(52) U.S. Cl. 426/393

(57) ABSTRACT

A packaged frozen confection product comprising a frozen confection item; a holder-stick for supporting the frozen confection item fixed to the frozen confection item; in combination with a handle element rotatably attachable to the holder-stick for holding the frozen confection with one hand and a crank fixedly attachable to the holder-stick for rotating the holder-stick with the other hand.

### CROSS REFERENCE TO RELATED APPLICATION

This application is a continuation-in-part of PCT/EP05/010665, which bears an international filing date of Oct. 4, 2005, and claims priority to Chilean Application No. 26012004 filed Oct. 8, 2004.

### BACKGROUND

The subject of the present invention is a device that can be used to rotate an object such as a frozen confection and is a packaging support for that frozen confection. Thus the invention also relates to a frozen confection product having a stick that supports a frozen confection and enables the user to rotate the product as desired while it is consumed.

A wide variety of articles for consumption by a user that are supported by various types of wooden or plastic holder-sticks are currently available on the market. When consuming a frozen dessert in a constant and regular manner, the user has to rotate the frozen dessert by hand in order to get access to all sides of the dessert. Rotating the dessert by hand is inconvenient and has the risk that the frozen dessert may be dropped or drip and perhaps stain clothing.

Thus there is a need for improved devices to support articles for consumption that do not require rotating the dessert by hand.

U.S. Pat. Nos. 5,209,692, 5,391,107 and 5,676,988 are concerned with battery-operated candy holding devices. U.S. Pat. No. 5,676,988 further discloses a toy in the form of a flying disc which can be connected to a spinner end. All these candy holder devices are complicated and voluminous.

In the art of making ice cream and water ice stick lollies, it is essential that the sticks are of compact shape in order to be able to fit in a stick bar production line. Thus, in that prior art the body of the holder is either far too complicated, voluminous and heavy to be able to suit the requirements for handling ice lollies in food manufacturing lines. Furthermore, the electrically powered arrangement with battery, electrical circuit and motor would not be compatible with frozen confections manufacturing wet environment.

U.S. Pat. No. 6,221,409 is concerned with a rotatable support for a frozen confection in the form of a stick assembly which, in addition to allowing to rotate an ice lolly on a support stick for consumption has a play value for kids in that, after consumption the stick-assembly can receive a spinning top or a flying toy. A problem is that the stick assembly alone is composed of six different parts, some of which are rotative and others are fixed, which must be assembled at the production site in the plastic stick manufacturing factory and adds complexity and costs. On top of this, the stick is adapted to ball-shaped ice lollies with the objective that the product is consumed while being turned in the mouth, and therefore the stick cannot receive an elongated ice bar, which would be suited to regular stick bar moulding lines. Another problem is that the system has two functions which are somewhat contradictory the one to the other, on the on hand bearing a high speed rotary toy and on the other hand allowing slow rotation during consumption, which functions are not always well used by the consumer, the kids tend to rotate the ice lolly at too high a speed before or during consumption with the consequence of dripping, spillage and possibly clothing staining.

The present invention eliminates the drawbacks of the previous stick assemblies.

### SUMMARY

The present invention thus relates to a device for rotating a frozen confection item comprising:

a holder-stick for supporting the frozen confection item fixed to the frozen confection item;

a hand-grip element rotatably attached to the holder-stick for holding the frozen confection with one hand and

a crank fixedly attached to the holder-stick for rotating the holder-stick with the other hand.

The invention further relates to a packaged frozen confection product comprising:

a frozen confection item;

a holder-stick for supporting the frozen confection item fixed to the frozen confection item;

in combination with:

a handle element rotatably attachable to the holder-stick for holding the frozen confection with one hand and

a crank fixedly attachable to the holder-stick for rotating the holder-stick with the other hand.

Additional features and advantages are described herein, and will be apparent from, the following Detailed Description and the figures.

### BRIEF DESCRIPTION OF THE FIGURES

The following drawings illustrate as a non-limiting example a preferred embodiment of the invention, in which

FIG. 1 shows an exploded view in perspective of the frozen confection rotating device in three parts 1, the crank, 2, the holder-stick and 3, the handle;

FIG. 2 is a view in elevation of parts 2 and 3, showing how the holder-stick 2 is introduced into the handle 3;

FIG. 3 and 4 are views, in perspective under different angles of the assembled rotating device;

FIG. 5 shows a detailed view in elevation of the way parts 1 and 3 are assembled;

FIG. 6 shows a detailed view in perspective of the way parts 1, 2 and 3 are assembled;

FIG. 7 is a view in perspective of a frozen confection product embodying the rotating device and

FIG. 8 is a view in perspective of an alternative frozen confection product embodying the rotating device.

### DETAILED DESCRIPTION

The rotating device comprises three parts.

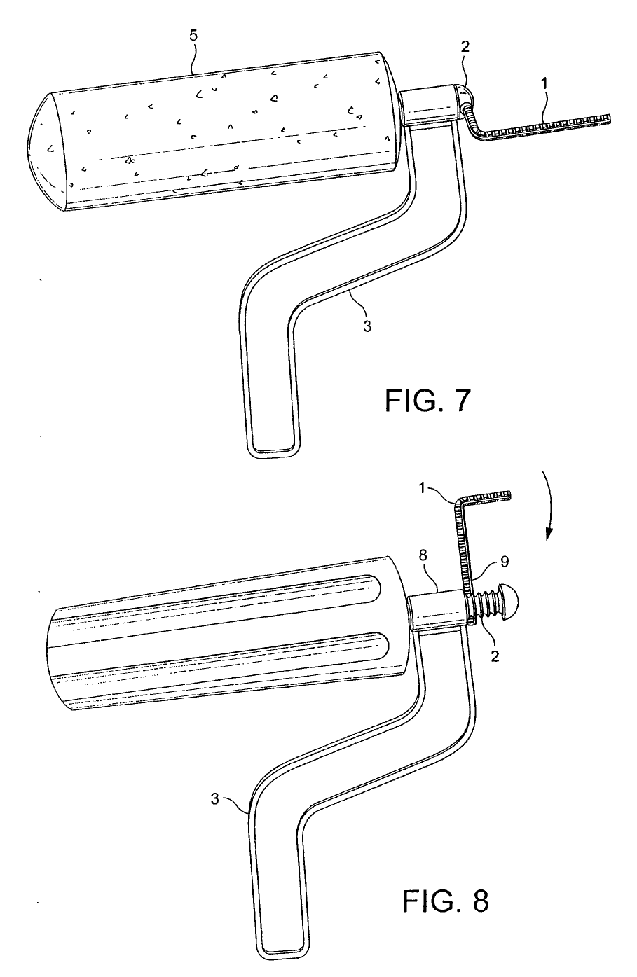

As a first part the holder-stick 2 is made of resilient moulded plastics and comprises an elongated body of general cruciform section with radial circle elements 4 which serve to anchor the stick into a frozen confection mass 5 (FIG. 7, 8). Near to one of its ends the holder stick 2 is in the form of a grooved peg 6 with a oval slot 7 inside.

A second part, the handle 3 is S shaped and generally flat with a hollow cylindrical end 8 which serves as a bearing for the holder-stick 2. As shown in FIG. 2, the hollow end 8 is force inserted around the holder-stick 2 as shown with the arrow f1, so that the holder-stick is rotatably fixed to the handle 3 and can rotate freely inside it.

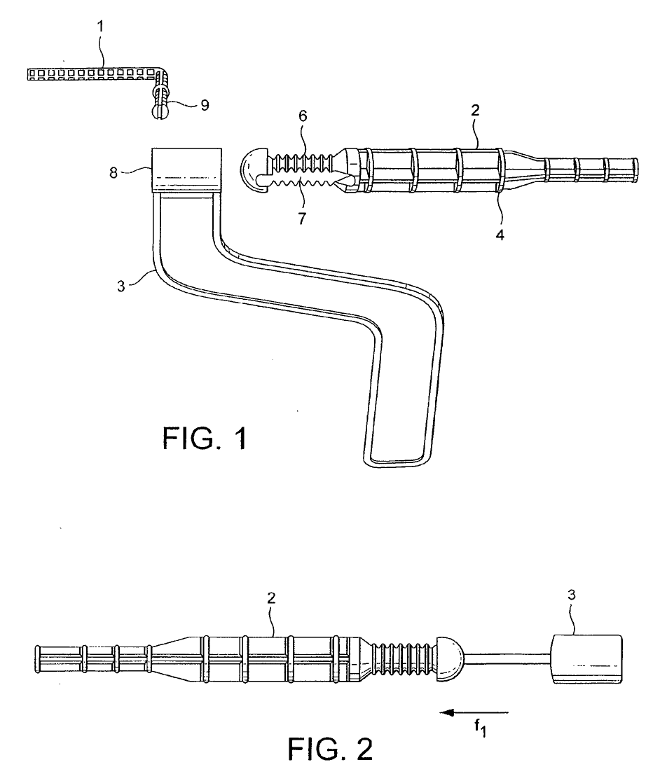

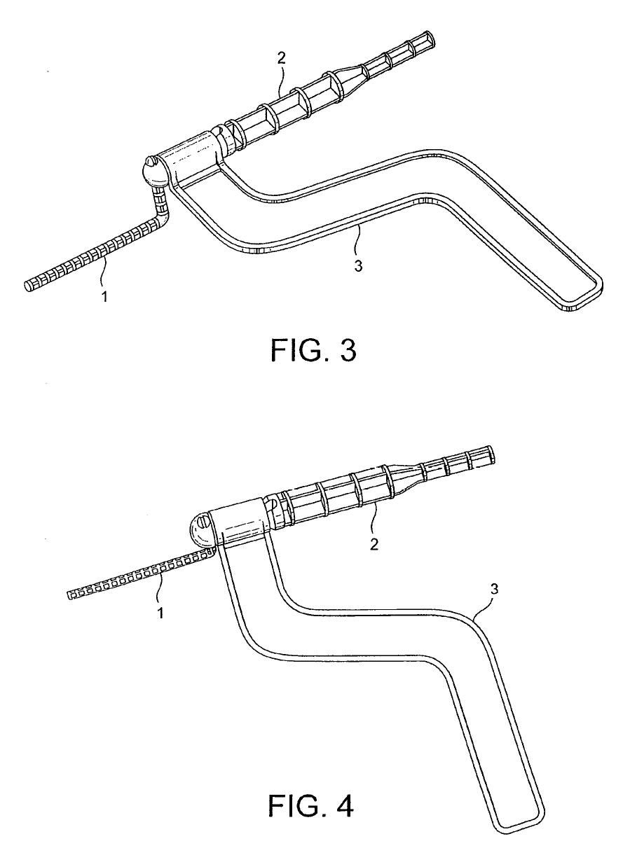

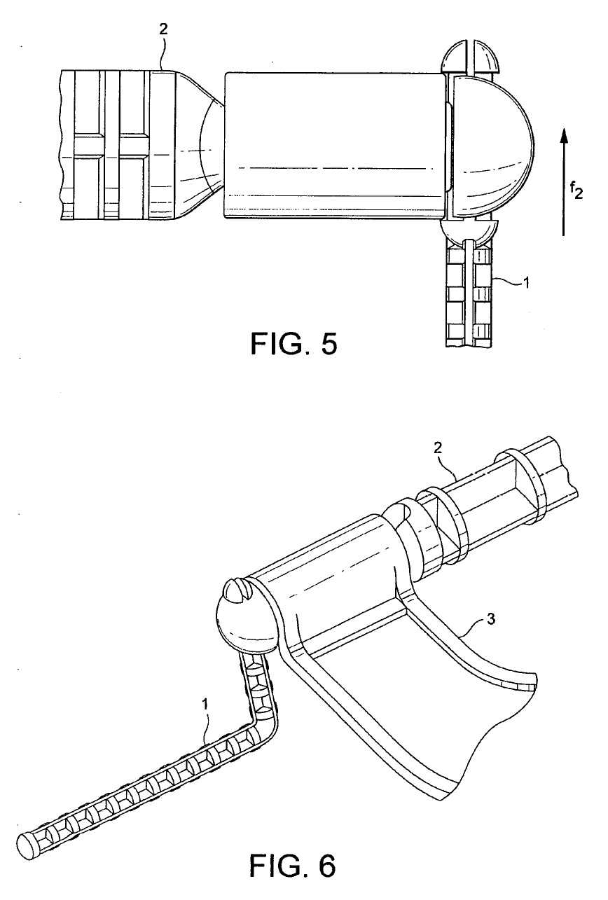

As shown in FIG. 1, a third part, the crank 1 is L shaped and the shorter branch of the L is terminated with a slotted peg 9. FIG. 5 indicates the way the crank 1 is fixedly inserted into the hole 7 of the holder-stick 2, in a direction perpendicular to the length of the holder-stick 2, as shown with the arrow f2.

A quasi-cylindrical frozen confection body 5 (FIG. 7) is moulded around the holder stick 2 using a conventional stick moulding machine using the steps of filling the moulds travelling into a refrigerated medium with a composition for water ice, vertically inserting the holder-stick 2 when the composition is in semi-solid state, continuing cooling the mould containing the composition for water ice until it is solid enough for holding the stick in upright position, surface heating the mould, demoulding the lolly and packing it. Preferably, the finished ice lolly is prepacked, e.g. in a flow pack separately from the second and third parts of the rotating device and the separate parts are packed together with the prepacked product, e.g. in a flow pack.

There is a play function in the device of the invention, since the consumer, the kid, receives in addition to the ice lolly two plastic parts, a handle 3 and a crank 1 and is asked to interact with the product in a sense that he has to build the rotating device. For doing so, he first inserts the handle 3 around the stick 2 as shown in FIG. 2 and then the crank with its lower arm into the hole 7 of the holder-stick 2.

Gripping the holder 2 with one hand, supposed that he is left-handed, the consumer acts on the crank 1 with his right hand and thus rotates the ice lolly while consuming it (FIGS. 7 and 8).

In the embodiment of FIG. 8, the holder-stick 2 is somewhat longer and protrudes from the top surface of the frozen confection body in such a way that it is easier to demould the product in a conventional stick moulding line by gripping the stick. The frozen confection is a striped water ice in two flavours, pineapple and apple. The crank 1 is inserted into the hole 7 in the holder-stick 2, which hole is at a certain distance from the upper end 8 of the stick. The crank 1 is inserted into that hole from the longer arm 9 of the L.

The bottom end of the frozen dessert stick 2 may have a shape which makes it suitable for the fitting of various additional accessories which may convert the frozen dessert stick, after the frozen dessert has been consumed, into a number of toys such as a whisk, a spinning top and rotary and/or flying toys without departing from the spirit of the invention.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. Device for rotating a frozen confection item comprising:
a holder fixed to the frozen confection item;
a handle rotatably attached to the holder for holding the frozen confection with one hand; and
a crank fixedly attached to the holder for rotating the holder with the other hand.

2. Device according to claim 1, wherein the holder is made of a resilient moulded plastic and comprises an elongated body of general cruciform cross-section with radial circle elements.

3. Device according to claim 1, wherein near an end of the holder, the holder has a form of a grooved peg with a oval slot inside.

4. Device according to claim 3, wherein the crank is L shaped and one branch of the L is terminated with a slotted peg, and is fixedly inserted into the oval slot of the holder in a direction perpendicular to a length of the holder.

5. Device according to claim 1, wherein the handle has an S shape and generally flat portion with a hollow cylindrical end which serves as a bearing for the holder, and is so constructed and arranged that the holder is rotatably fixed to the holder and can rotate freely inside it.

6. Device according to claim 1, wherein the crank is L shaped.

7. Packaged frozen confection product comprising:
a frozen confection item;
a holder for supporting the frozen confection item fixed to the frozen confection item;
a handle element rotatably attachable to the holder for holding the frozen confection with one hand; and
a crank fixedly attachable to the holder for rotating the holder-stick with the other hand.

8. A product according to claim 7, wherein the frozen confection item is a water ice stick.

9. A product according to claim 8, prepacked separately from the handle and the crank.

10. A product according to claim 7, prepacked separately from the handle and the crank.

11. Device for a frozen confection comprising:
a holder supporting the frozen confection item;
a handle element rotatably attached to the holder; and
a crank fixedly attached to the holder for rotating the holder.
